(19) United States
(12) Patent Application Publication
(10) Pub. No.: US 2008/0070167 A1
(43) Pub. Date: Mar. 20, 2008

(54) EXPOSURE AND DEVELOPING METHOD

(75) Inventors: Nobuhiro TAKAHASHI, Nirasaki-shi (JP); Satoru SHIMURA, Nirasaki-shi (JP); Tetsu KAWASAKI, Nirasaki-shi (JP); Hideharu KYOUDA, Koshi-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 11/853,416

(22) Filed: Sep. 11, 2007

(30) Foreign Application Priority Data
Sep. 15, 2006 (JP) 2006-250293
Feb. 21, 2007 (JP) 2007-040297

(51) Int. Cl. G03C 5/00

(52) U.S. Cl. 430/330

(57) ABSTRACT

An exposure and developing method includes a step of exposing a resist film having a protective surface on a surface thereof in the state that a liquid layer transparent to light is formed on the resist film, and developing the resist film after the exposure, wherein there is further provided a cleaning step for cleaning the surface of the resist film before the developing step with a cleaning liquid that contains a solvent of the protective film.

### BACKGROUND OF THE INVENTION

The present invention generally relates to exposure and developing methods and more particularly to an exposure and developing method that carries out exposure to a resist film formed on a substrate to be processed and formed with a protective film on a surface thereof, in the state in which there exists a liquid layer (liquid immersion exposure), followed by a developing process.

Exposure and developing process is an important process element in the fabrication process of semiconductor devices.

In exposure and developing processes, a resist film is formed on a surface of a semiconductor wafer (referred to hereinafter as “wafer”) by applying thereto a resist, and the resist film thus formed is exposed according to a predetermined pattern. Further, the resist film is developed, and with this, a resist pattern of the desired, predetermined pattern is formed.

With the demand of miniaturization and thinning of device patterns, there is an increasing demand for higher exposure resolution.

One approach of attaining higher exposure resolution is to use a liquid immersion exposure technology, which is an improvement of the existing exposure technology that uses short wavelength optical source such as argon fluoride (ArF) or krypton fluoride (KrF) excimer lasers. With such liquid immersion exposure technology, exposure is made upon a wafer in the state that there is formed a liquid layer transparent to the exposure light.

Thus, liquid immersion exposure technology causes the exposure light to propagate through water such as purified water and utilizes the phenomenon in which wavelength of the exposure light becomes shorter in water. For example, it is possible to carry out exposure with the wavelength of substantially 134 nm in water while using the ArF optical source, which produces optical radiation with the wavelength of 193 nm.

Thus, a liquid immersion exposure process is a technology that transfers a desired resist pattern (circuit pattern) to a resist film by irradiating a light emitted from an optical source upon a wafer via a liquid film in the state that the liquid film (water film) is formed between the lens and the wafer surface.

Further, with the liquid immersion exposure technology, the exposure optical system is moved or slid horizontally to a next exposure region (shot region), when exposure to a current region is completed, in the state that the liquid film exists between the wafer and the exposure optical system, and the circuit pattern is transferred to the shot regions on the wafer surface one after another by repeating the optical exposure process.

On the other hand, with such liquid immersion exposure technology, there arises a problem, because of existence of liquid film (water film) between the lens and the wafer, that a part of the resist composition may be dissolved from the resist surface and adhere to the lens surface of the exposure system. When this occurs, there is caused degradation in the circuit pattern transferred to the resist film with regard to the line width. Further, even in the case such adhesion of dissolved compositions upon the lens surface is not caused, existence of the dissolved resist compositions may modify the refractive index of the water film through which the exposure light is propagated, and thus, there may be caused degradation of resolution or in-plane non-uniformity in the precision of exposed line widths in the circuit pattern transferred to the resist film.

In order to solve the foregoing problems, there is proposed a method of cleaning the resist surface applied upon the wafer in advance to the exposure with a cleaning liquid for suppressing the amount of the resist compositions dissolved from the resist film into the liquid layer formed on the wafer surface at the time of the liquid immersion exposure process (see Patent Reference 1).

Further, there is proposed formation of an anti-reflection coating (protective film) on the surface of the resist film for reducing deformation of the resist pattern caused by optical reasons (see Patent Reference 2, for example).

### Patent Reference 1

Japanese Laid-Open Patent Application 2005-294520 Official Gazette

### Patent Reference 2

Japanese Laid-Open Patent Application 2006-80404 Official Gazette

### SUMMARY OF THE INVENTION

However, with liquid immersion exposure technology, the exposure optical system drags the liquid formed between the lens and the wafer surface at the time of liquid immersion exposure, while this tends to cause formation of water droplets or bubbles upon the wafer surface. Thus, when the wafer carrying such water droplets or bubbles is dried as it is, there are formed particles, watermarks, drying stains, or the like on the resist surface.

While water droplets remained on the wafer surface may be removed by cleaning the wafer surface after the exposure, it is impossible to remove watermarks or drying stains formed on the resist surface by cleaning.

Further, in the case there is formed a protective film on the resist film surface, it is possible to suppress the damages applied directly to the resist film itself, while it is not possible to avoid formation of the particles or stains on the surface of the protective film after the exposure, and it has not been possible to remove such particles or stains without causing damages to the resist film with the cleaning process used conventionally after the exposure process.

The present invention has been made under these circumstances and it is the object of the present invention to provide an exposure and developing method capable of exposing and developing a high resolution pattern with high in-plane precision, by removing watermarks or stains formed at the time of the liquid immersion exposure process, without causing damages to the resist film.

According an aspect of the present invention, there is provided an exposure and developing method, comprising the steps of:

exposing a resist film formed on a substrate to be processed and carrying a protective film on a surface thereof with an exposure light, in the state that there is formed a liquid layer transparent to said exposure light upon said resist film; and

developing said resist film after said exposing step,

wherein there is provided a cleaning step before said developing step, with a cleaning liquid that contains a solvent of said protective film.

Preferably, a heat treatment process heating the resist film is conducted after the cleaning step for stabilizing the resist film.

Preferably, the cleaning step carries out the cleaning with the cleaning liquid either in a state in which a surface part of the protective film is removed or in a state in which the protective film is removed for an entirety thereof.

Preferably, a time interval from an end of the cleaning step to a start of the heating step is controlled constant in the case of carrying out the cleaning step while removing the protective film for an entirety thereof.

The cleaning liquid may be any arbitrary solvent of the protective film of the resist film, wherein it is preferable that the cleaning liquid is a solvent of the material commonly used for the protective film and soluble to the developing liquid such as: 2-butanol, n-decane, 2-octanol, n-pentanol, isobutyl alcohol, diisoamyl ether, 2-methyl-1-butanol, dibutyl ether, 2-methyl-2-butanol, 2-methyl-4-pentanol, or a mixture thereof.

As a result of the foregoing construction, following advantageous results are attained according to the present invention.

(1) It is possible to positively remove the water droplets, particles, stains, or the like formed on the surface of the resist film covering the substrate to be processed at the time of the liquid immersion exposure process, by solving the protective film by a cleaning liquid that contains the solvent of the protective film. Because it is possible with the present invention to carry out the developing process in the state the water droplets, particles or stains formed on the surface of the substrate to be processed are removed, it becomes possible to improve the resolution and improve the in-plane precision for the line width of the exposed patterns.

(2) By heating the substrate to a predetermined temperature after the cleaning process, the resist film is stabilized with regard to film thickness or photo-acid reactions occurring therein, and thus, there is attained an advantageous feature, in addition to the foregoing advantageous feature (1), that it is possible to suppress chemical change of the resist film before the exposure, such as chemical reaction caused in a chemical amplification resist by amines, ammonias, or the like.

(3) In the case of carrying out the cleaning process while removing the protective film entirely, it is possible to attain an advantageous feature, in addition to the advantageous features (1) and (2), of enabling uniform developing processing over a plurality of substrates, by controlling the interval from the end of the cleaning processing to the start of the heating process for the substrates.

(4) By using 2-butanol, n-decane, 2-octanol, n-pentanol, isobutyl alcohol, isodiamyl ether, 2-methyl-1-butanol, dibutyl ether, 2-methyl-2-butanol, 2-methyl-4-pentanol, or a mixture thereof, used for the solvent of the protective film (formed of a material soluble to developing liquid) for the cleaning liquid, it becomes possible to remove the water droplets, particles, stains or the like formed on the surface of the protective film positively, without causing damages to the resist film.

### BRIEF DESCRIPTION OF THE DRAWINGS

FIG. 1 is a schematic plan view diagram showing the overall construction of a processing system in which a coating and developing apparatus, in which the exposure and developing process of the present invention is applied, is coupled with an exposure apparatus;

FIG. 2 is a schematic oblique view diagram of the processing system of FIG. 1;

FIG. 3 is an oblique view diagram showing an interface part used in the processing system of FIG. 1;

FIGS. 4A and 4B are respectively a cross-sectional diagram showing a cleaning apparatus in the processing system of FIG. 1 and an enlarged cross-sectional diagram showing a part of FIG. 4A with an enlarged scale;

FIG. 4C is a diagram showing a part of the immersion exposure system schematically;

FIGS. 5A and 5B are enlarged cross-sectional diagrams showing different modes of cleaning process conducted after a liquid immersion exposure system of the present invention;

FIG. 6 is a cross-sectional diagram showing a heating and cooling unit used in the processing system of FIG. 1;

FIG. 7 is a flowchart showing a process flow of coating, exposure and developing;

FIG. 8 is a graph showing the result of experiments conducted for confirming the effect of the present invention and thus comparing the number of residual stains;

FIG. 9 is a graph showing the result of experiments conducted for confirming the effect of the present invention and thus comparing the number of residual particles;

FIG. 10 is a graph showing the result of experiments conducted for confirming the effect of the present invention and thus comparing the amount of decrease of resist film thickness;

FIGS. 11A-11E are schematic cross-sectional diagrams showing a surface potential and particle transfer mechanism in a comparative experiment conducted for confirming the effect of the present invention;

FIGS. 12A-12D are schematic cross-sectional diagrams showing a surface potential and particle transfer mechanism in an experiment conducted for confirming the effect of the present invention.

### DETAILED DESCRIPTION OF THE PREFERRED EMBODIMENTS

Hereinafter, the present invention will be described in detail for the best modes of the invention with reference to the drawings.

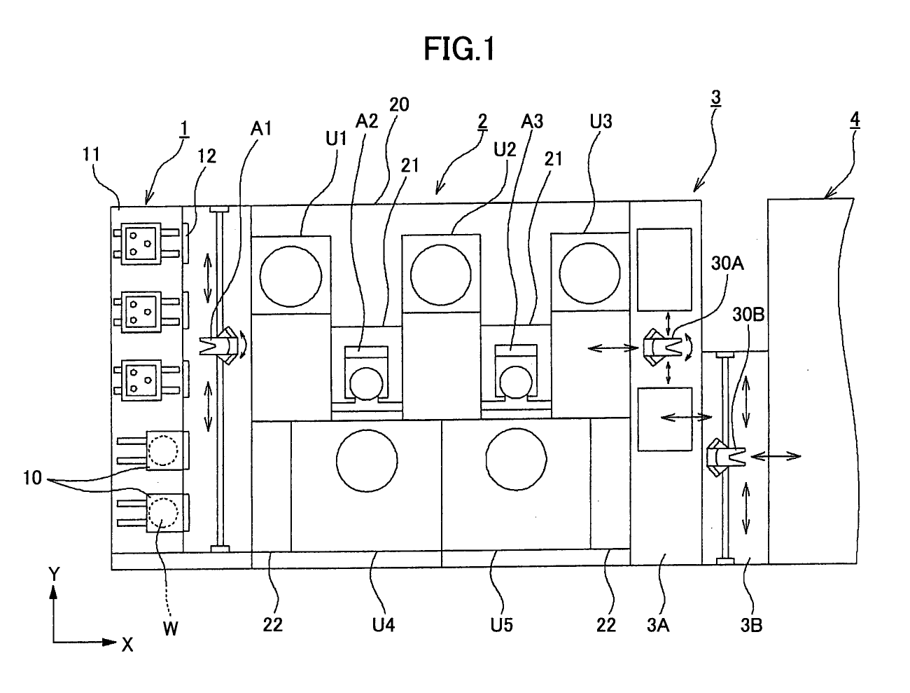

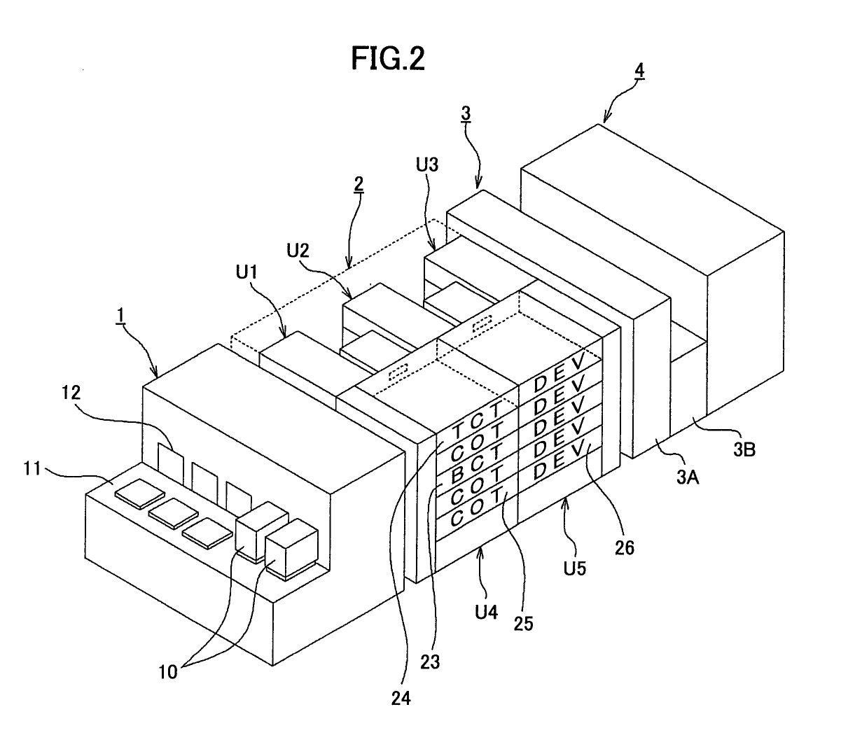

FIG. 1 is a schematic plan view diagram showing the overall construction of a processing system in which a coating and developing apparatus, in which the exposure and developing process of the present invention is applied, is coupled with an exposure apparatus, while FIG. 2 is a schematic oblique view diagram of the processing system of FIG. 1.

Referring to FIGS. 1 and 2, the processing system includes a carrier station 1 for loading and unloading a carrier 10, in which a plurality of semiconductor wafers W (referred to hereinafter as “wafer W”), such as 25 wafers W, are accommodated in a sealed-up state, a processing part 2 that picks up a wafer W from the carrier station and applies thereto a resist coating process and developing process, an exposure part 4 that carries out liquid immersion exposure process to the surface of the wafer W with an exposure light in the state that there is formed a liquid layer transparent to the exposure light on the surface of the wafer W, and an interface part 3 interposed between the processing part 2 and the exposure part 4 for transferring the wafer W therebetween.

The carrier station 1 includes a loading part 11 capable of placing a plurality of carries 10 simultaneously, an open/close part 12 provided to a front wall when viewed from the loading part 11, and a transfer unit A1 for picking up a wafer W from the carrier 10 via the open/close part 12.

Behind the carrier station 1, the processing part 2 is connected in a state surrounded with a casing 20, wherein the processing part 2 is provided with main transfer units A2 and A3 for transferring the wafer W between shelf units U1, U2 and U3 in which heating and cooling units are stacked in multiple stacks and liquid processing units U4 and U5, in such a manner that the main transfer units A2 and A3 are disposed alternately.

Thereby, the main transfer units A2 and A3 are disposed in respective spaces each defined by rear and front walls of two of the shelf units U1, U2 and U3, a side wall of one of the liquid processing units U4 and U5 located at the right side, and a compartment wall 21 located at the left side of the space.

Further, between the carrier station 1 and the processing unit 2, and between the processing unit 2 and the interface part 3, there is disposed a temperature and humidity adjustment unit 22, which in turn is equipped with temperature adjustment apparatuses for the processing liquids used in the units, ducts for temperature and humidity adjustment, or the like.

The shelf units U1, U2 and U3 have the construction of stacking various units for preprocessing and post processing of the liquid processing conducted in the liquid processing units U4 and U5 in plural stacks, 10 stacks for example, wherein the stack may include the combination of a heating unit (HP) for baking a wafer W and a cooling unit (CPL) for cooing a wafer W.

Further, the liquid processing units U4 and U5 have the construction of stacking, as shown in the example of FIG. 2, a bottom anti-reflection film coating unit (BCT) 23 coating a bottom anti-reflection film, a top anti-reflection film coating unit (TCT) 24, a coating unit (COT) 25 coating a top anti-reflection film, a developing unit developing a resist pattern by supplying a developing liquid upon the wafer W, and the like, over a chemical liquid holding part holding therein a resist or developing liquid, in the form of multiple stacks such as 5 stacks.

It should be noted that this coating and developing apparatus comprises a first cleaning unit cleaning the wafer W coated with a resist with a cleaning liquid in advance of the exposure process, and a second cleaning unit cleaning the wafer W after the exposure process, wherein the first cleaning unit and the second cleaning unit are provided to the interface part 3 in the illustrated example as will be explained later.

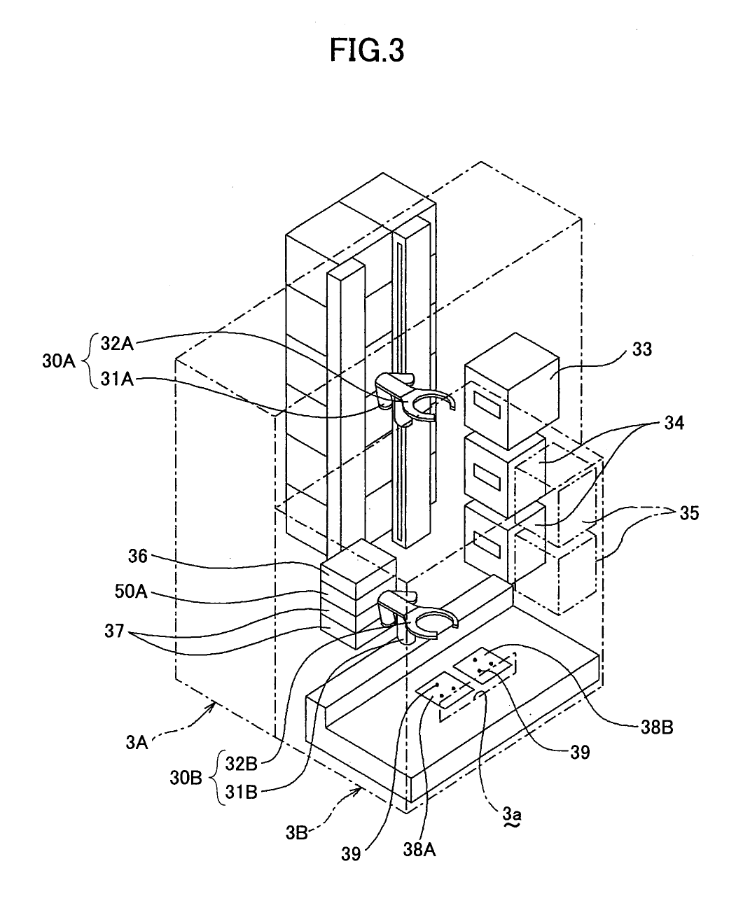

As shown in FIG. 3, the interface part 3 is formed of a first transfer chamber 3A and a second transfer chamber 3B provided respectively at the near side and far side between the processing part 2 and the exposure part 4, wherein the first and second transfer chambers 3A and 3B are provided respectively with a first wafer transfer part 30A and a second wafer transfer part 30B.

The first wafer transfer part 30A comprises a base body 31A movable up and down and rotatable about a vertical axis and an arm 32A provided on the base body 31A in a manner movable forward and backward as desired. Further, the second wafer transfer part 30B comprises a base body 31B movable up and down and rotatable about a vertical axis and an arm 32B provided on the base body 31B in a manner movable forward and backward as desired.

Further, it should be noted that the timing and the duration of transporting the wafer W with the first and second wafer transfer parts 30A and 30B are controlled by a controller 70 to be described later, wherein the controller 70 is formed primarily of a central processing unit (CPU) of a control computer used for the control means.

Further, in the first transfer chamber 3A, there are provided a peripheral exposure apparatus (WEE) 33 for selectively exposing an edge part of the wafer W and two cleaning apparatuses 34 for cleaning the wafer W after exposure at the left side in the form of a stack when viewed from the carrier station 1 with regard to the first wafer transfer part 30A, and there are provided two buffer cassettes 35 each accommodating 25 wafers temporarily also in the form of a stack.

Similarly, there are provided, at the right side thereof, a transfer unit 36, two high-precision temperature adjustment units 37 each having a cooling plate and a heating and cooling unit (PEB) 50A for applying a PEB processing to the wafer W subjected to the exposure process in the form of a stack.

Further, there are provided transfer stages 38A and 38B for transferring a wafer W between the second transfer chamber 3B and the exposure part 4 via a wafer transfer opening 3a formed in the exposure part 4 respectively at the left side and the right side. It should be noted that each of the transfer stages 38A and 38B is provided with three substrate supporting pins 39 for supporting the wafer W from a rear side thereof.

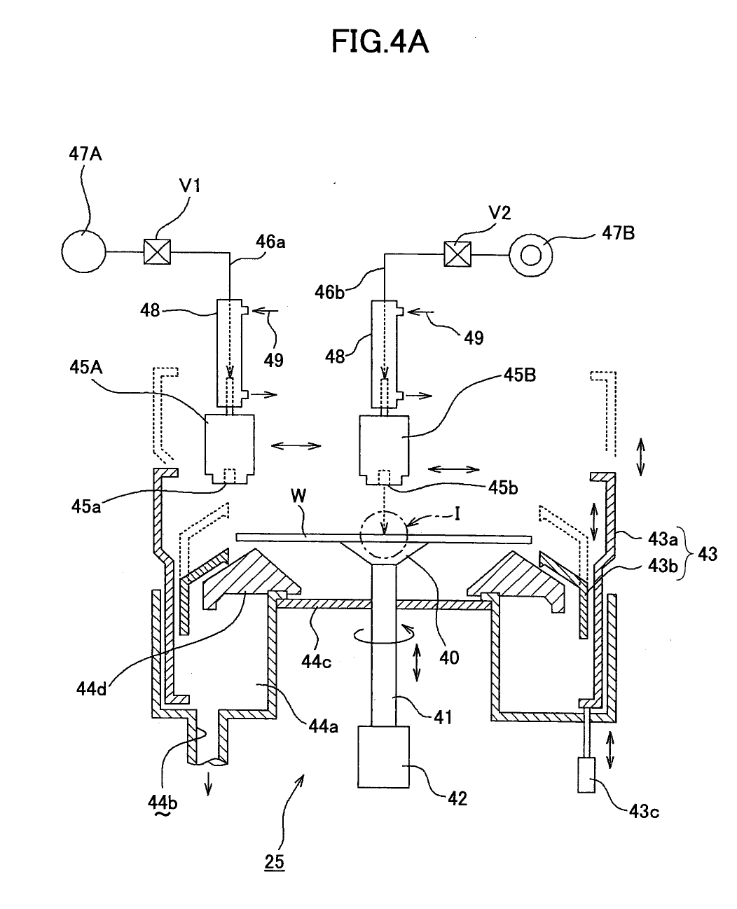

As shown in FIG. 4A, the cleaning apparatus 34 is equipped with a spin chuck 40 that constitutes a substrate holding part that holds the wafer W horizontally by sucking upon the central part of the wafer W at the rear surface thereof.

The spin chuck 40 is connected to a drive mechanism 42 via an axial part 41 and has a construction movable up and down and rotatable by the foregoing drive mechanism 42 in the state that the wafer W is held thereon. While not illustrated, the drive mechanism 42 is connected to the controller 70 functioning as the control means electrically and controls the rotational speed of the spin chuck 40 based on a control signal from the controller 70.

Further, there is provided a cup body 43 including an outer cup 43a opened at a top part thereof and an inner cup 43b so as to surround the wafer W held on the spin chuck 40.

The outer cup 43a is movable up and down by an elevating part 43c and is constructed so as to lift up the inner cup 43b from lower side in a lifted up state, by means of a stepped part formed at a bottom part of the outer cup 43a.

Further, there is provided a liquid collection part 44a at the bottom part of the cup body 43 in a depressed form such that the liquid collection part 44a surrounds the entire periphery of the wafer W. There is provided a drain opening 44b at the bottom part of the liquid collection part 44a. Further, there is provided a circular plate 44c at the lower side of the wafer W, and there is provided a ring member 44d so as to surround the outer periphery of the circular plate 44c.

At the upper side of the wafer W held on the spin chuck 40, there are provided first and second cleaning liquid supply nozzles 45A and 45B equipped with respective cleaning liquid election ports 45a and 45b of a slit shape having a length equal to or larger than the diameter of the wafer W to be processed, in such a manner that the first and second liquid supply nozzles 45A and 45B are movable forward and backward and up and down as desired.

The liquid supply nozzles 45A and 45B are connected respectively to sources 47A and 47B of the cleaning liquid via supply paths 46a and 46b provided respectively with open/close valves V1 and V2 capable of adjusting the flow rate of the liquid flowing therethrough.

In the illustrated construction, purified water is used in the supply source 47A connected to the first cleaning liquid supply nozzle 45A as the cleaning liquid.

Further, the supply source 47B connected to the second cleaning liquid supply nozzle 45B holds a solvent of the top anti-reflection coating film (protective film) laminated upon the resist film as the cleaning liquid. The cleaning liquid held in the supply source 47B is a solvent soluble to the developing solution and may be any of: 2-butanol, n-decane, 2-octanol, n-pentanol, isobutyl alcohol, isoamyl ether, 2-methyl-1-butanol, dibutyl ether, 2-methyl-2-butanol, 2-mtyl-4-pentanol or a mixture thereof.

The valves V1 and V2 are opened and closed in response to the control signal from a control means not illustrated so as to adjust the flow rate, and a predetermined amount of the solvent is supplied (discharged) to the surface of the wafer W as shown in FIG. 4B.

In the example of FIG. 4B, a resist film R is formed on the wafer W via a bottom anti-reflection coating BARC and a protective film TC is formed on the resist film R thus formed. Further, 2-butanol is supplied as the cleaning liquid.

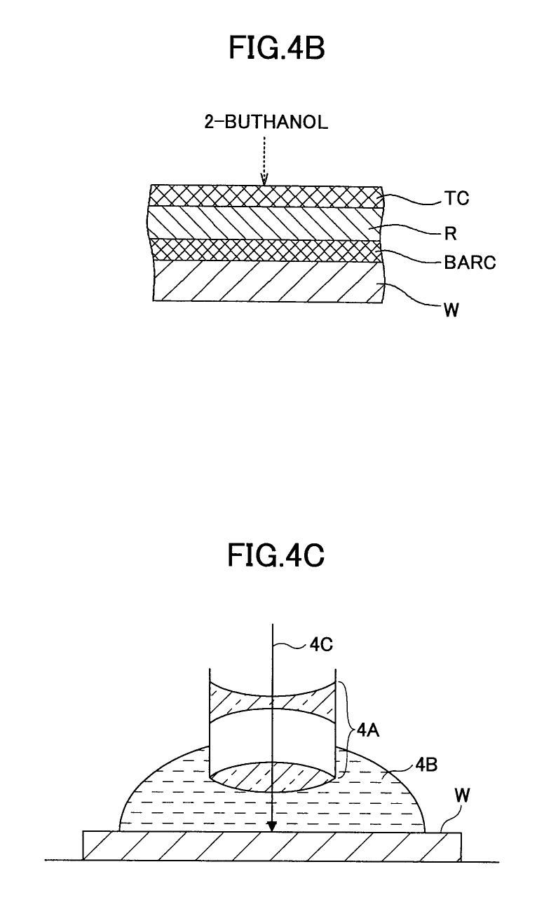

Particularly, it becomes possible with the present embodiment to remove only a surface part of the protective film TC laminated upon the surface of the resist film R as shown in FIG. 5A, by adjusting the supply amount (discharge amount) of the cleaning liquid such as 2-butanol that becomes the solvent of the protective film, by adjusting the supply amount (discharge amount) of the cleaning liquid used for the solvent of the protective film such as 2-butanol, or the like. Alternatively, it is possible to remove the entirety of the protective film TC by dissolving, by increasing the supply amount (discharge amount) of the cleaning liquid.

Thereby, it is also possible to adjust the peeling of the protective film TC by changing the rotational speed of the spin chuck 40, in addition to the adjustment of the supply amount (discharge amount) of the cleaning liquid.

Further, the first and second cleaning liquid supply nozzles 45A and 45B are equipped with respective temperature adjustment parts 48 for adjusting the temperature of the respective cleaning liquids.

The temperature adjustment part 48 is configured to have a dual tube structure in that there is provided a flow path 49 of temperature adjustment water so as to surround the supply path 46a or 46b of the cleaning liquid, and the temperature of the cleaning liquid is adjusted with this temperature adjustment water.

The temperature of the cleaning liquid is determined according to the type of the resist. In the case of using a resist that provides better results when cleaned with the cleaning liquid of low temperature, the temperature of the cleaning liquid may be set to 23° C., for example.

In the case of using a resist that provides better results when cleaned with a cleaning liquid of higher temperature, the temperature of the cleaning liquid may be set to 50° C., for example. Determination of the cooling liquid temperature may be made by conducting a test in advance. Thus, the preset value of the cooling liquid temperature is memorized to a storage part of a computer not illustrated for each of the resists and the temperature adjustment part 48 is set to a process temperature at the time of processing by reading out this preset information.

Further, with the construction of FIG. 3, the heating and cooling unit (PEB) 50A that applies post exposure baking (PBE), which is a heat treatment process, to the wafer W after the exposure is equipped with a heat treatment unit 50.

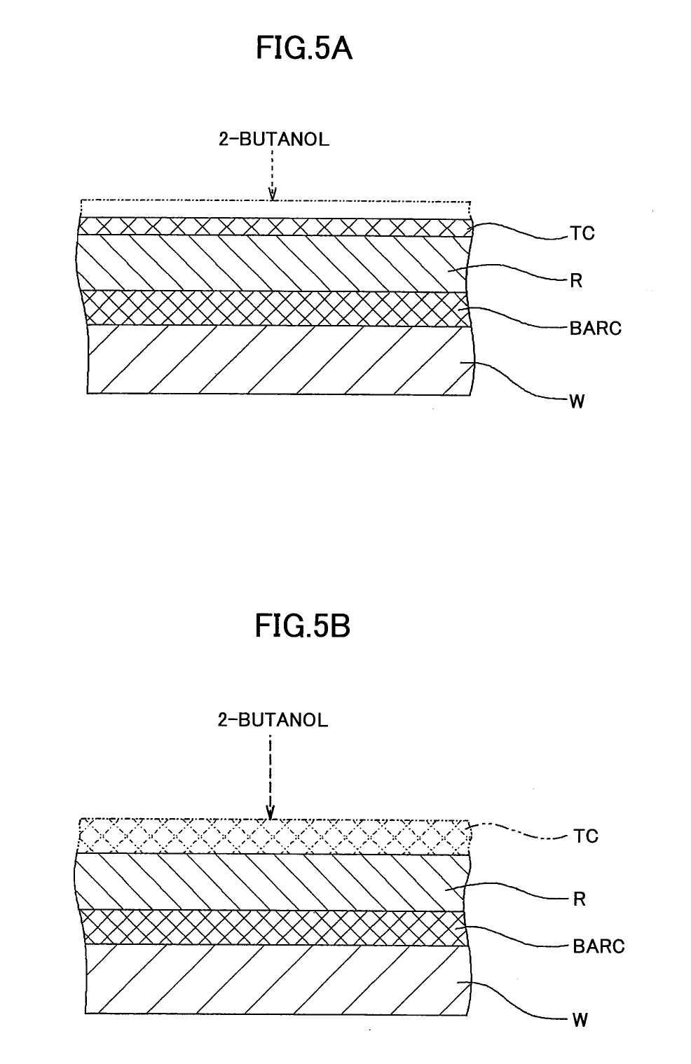

The heat treatment unit 50 comprises, as shown in FIG. 6, a heating part 50a heating the wafer W and a cooling part 50b cooling the wafer W inside a casing (not shown) of the heat treatment unit. The heating part 50a is provided with: a hot plate 51 for heating the wafer W placed thereon in the form a resist film is provided thereon as a coating film; a support base 52 provided so as to surround the hot plate 51 and supporting the bottom side of the hot plate 51; and a lid 55 forming a heat treatment chamber 54 in cooperation with a support ring 53.

The support ring 53 is provided, on the top surface thereof that makes a contact with the lid 55, with a groove 56 of circular form, and a seal ring 57 is fitted into the groove 56.

The hot plate 51 is embedded with a heater 58 controlled to a predetermined temperature by an output of a temperature control unit 58a, and there are provided three penetrating holes 59 on the hot plate 51 at the respective locations on a hypothetic concentric circle.

The penetrating hole 59 holds a support pin 61 in a manner movable up and down when driven by an elevating drive mechanism 60 provided at an underside of the hot plate 51, and the wafer W is transferred between the cooling part 50b and the cooling plate 62 in the state that the support pin 61 is lifted up.

Further, there is provided a support part 63 at one side of the lid 55, and a lid elevation mechanism such as a piston rod 65 of an elevation cylinder 64 is provided to the support part 63. Thus, the lid 55 moves to and from the support ring 53 in response to the driving of the elevating cylinder 64 between a closed state and opened state.

The elevating cylinder 64, the elevation drive mechanism 60 and the drive mechanism 66 of the cooing plate 62 are connected to the controller 70 electrically, such that the open/close operation of the lid 55 and the up/down movement of the support pin 61 are activated in response to a control signal from the controller 70.

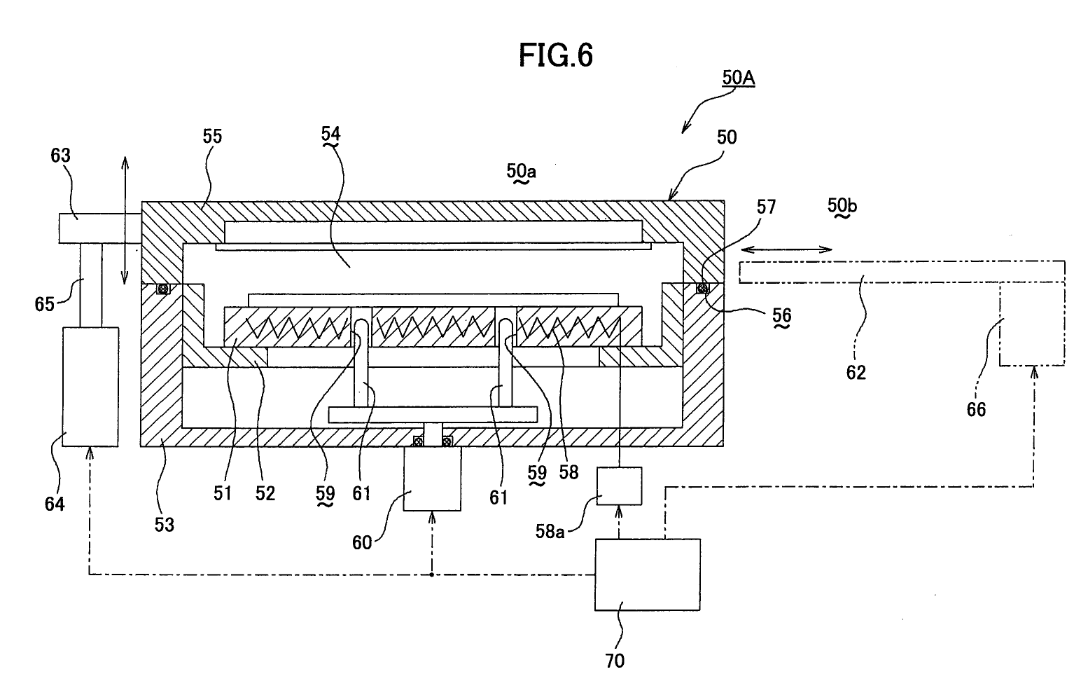

Next, the processing of the wafer W by using the foregoing coating and developing apparatus will be explained with reference to a flowchart shown in FIG. 7. Here, the case where there is formed a bottom anti-reflection coating (BARC) on the surface of the wafer W, a resist film is coated thereon and a top anti-reflection coating TC (referred to hereinafter as “protective film TC”) is laminated thereon will be explained.

Referring to FIG. 7, a carrier 10 accommodating therein thirteen wafers W, for example, is placed upon the loading part 11, and the lid of the carrier 10 is opened together with the open/close part 12. In this state, a wafer W is picked up by the transfer unit A1. The wafer W thus picked up is transferred further to the main transfer unit A2 via a transfer unit (not shown) that forms on stage of the shelf unit U1, wherein there is formed a bottom anti-reflection coating (BARC) film on the surface of the wafer W in the unit (BCT) 23 as preprocessing of the coating processing (step S1).

Thereafter, the wafer W is transferred to the heat treatment part of the shelf unit U1 by the main transfer unit A2 for prebaking processing (step S2).

Thereafter, the wafer W is transferred to the coating unit (COT) 25 by the main transfer unit A2, and a resist film is formed on the entire surface of the wafer W in the form of thin film (step S3).

Thereafter, the wafer W is transferred to the heat treatment part of the shelf unit U2 by the main transfer unit A2 for prebaking processing (step S4).

Thereafter, the wafer W is transferred to the unit (TCT) 24 by the main transfer unit, and a protective film TC is formed on the surface of the resist film (step S5).

Thereafter, the wafer W is transferred to the heat treatment part of the shelf unit U2 by the main transfer unit A2 for prebaking processing (step S6).

Thereafter, the wafer W is transferred to the transfer unit 36 by the main transfer unit A3 and is introduced into the cleaning apparatus 34 by the arm 32A of the interface part 3. Therein, the wafer W is held by the spin chuck 40. Further, in this state, the first cleaning liquid supply nozzle 45A is disposed so as to be located at an outer side of a first side the wafer W and the cleaning liquid such as purified water is supplied from the ejection port 45a with a predetermined flow rate. Further, the first cleaning liquid supply nozzle 45A is moved or slid to an opposite side of the wafer W in the state that the nozzle 45A is floating from the surface of the wafer W with a minute distance, such that the nozzle 45A scans over the surface of the wafer W.

With this, the cleaning liquid (purified water) is supplied to the surface of the wafer W, more precisely the surface of the top protective film TC. Thereby, the components of the protective film soluble to the cleaning liquid are dissolved, and with this, cleaning of the wafer W is attained (step S7).

In this step, it is possible to cause the cleaning liquid supply nozzle 45A to scan further from the opposite side to the first side, and repeat this process for several times. For example, the cleaning liquid supply nozzle 45 may be moved back and forth for two to three times. Alternatively, the nozzle 45A may be set still for a predetermined duration such as 2-10 seconds in the state that there is formed a buildup region of purified water on the surface of the wafer W by the action of surface tension.

Thereafter, the cleaning liquid supply nozzle 45A is retracted and the outer cup 43a is moved up together with the inner cup 43b. Further, the wafer W is rotated by the spin chuck 40 around a vertical axis with high speed, and spin drying is conducted by throwing off the cleaning liquid from the wafer W.

For example, it is possible to provide a dry gas nozzle for supplying a dry gas such as dry air or dry nitrogen in the unit and facilitate the drying process of the wafer W by applying the dry gas to the wafer W while carrying out the spin drying process. Alternatively, the spin drying process may be replaced by such a process of applying the dry gas.

With such a construction, it becomes possible to more positively suppress the problem of water marks formed on the surface of the wafer W at the time of the prebaking process and adversary effects are caused at the time of the exposure process.

Thereafter, the wafer W is taken out from the cleaning apparatus 34 by the arm 32A and is forwarded to the second wafer transfer part 30B and is placed upon the transfer stage 38A.

This wafer W is then introduced into the exposure part 4 through a wafer inlet opening 3a by a transfer means provided to the exposure part 4 but not illustrated, and an exposure optical system 4A is disposed so as to face the surface of the wafer W via a transparent water film 4B transparent to the exposure light 4C. In this state, the liquid immersion exposure is carried out (step S8) through the water film.

Thereafter, the wafer W finished with the liquid immersion exposure is placed upon the stage 38B by the transfer means not illustrated.

Next, the wafer W is taken out from the transfer stage 38B by the second wafer transfer part 30B and is forwarded to the first wafer transfer part 30A, wherein the wafer W is held by the spin chuck 40. In this state, the second cleaning liquid supply nozzle 45B is disposed so as to locate over the central part of the wafer W and the solvent of the top anti-reflection coating film (protective film TC) such as 2-butanol is discharged therefrom as the cleaning liquid with a predetermined flow rate.

With this, the cleaning liquid (2-butanol) is supplied to the surface of the wafer W, more precisely to the surface of the protective film, and there is caused dissolution of the protective film. Thereby, any water droplets or particles, stains, or the like formed on the surface of the wafer W, more precisely the surface of the protective film, at the time of the liquid immersion exposure are positively removed (step S9).

Thereby, it is also possible to cause the second cleaning liquid supply nozzle 45B to scan over the wafer W similarly to the first cleaning liquid supply nozzle 45A.

In this cleaning processing of water droplets, particles or stains, it is possible to choose whether to remove only a part (surface part) of the protective film (see FIG. 5A) or the entirety of the protective film (see FIG. 5B), by controlling the supply amount or supply (discharge) duration of the cleaning liquid (2-butanol) as explained above.

While the control of the supply amount or supply (discharge) duration of the cleaning liquid (2-butanol) may change depending upon the type or thickness of the resist film, while this can be determined in advance by experiments. Further, the foregoing modes of removing the protective film can be selected according to the needs.

When selecting the mode of removal, the following points should be taken into consideration.

When only a part (surface part) of the protective film is removed, there still exists the protective film on the surface of the resist film, and thus, it is not necessary to control the time interval after the liquid immersion exposure to the subsequent post exposure (PEB) process to be explained later. On the other hand, there is a concern that there may be left residue of the protective film on the surface of the resist film.

In the case the entirety of the protective film is removed, there is no concern about formation of residue of the protective film on the surface of the resist film. On the other hand, there arises a need of controlling the interval from the cleaning processing to the post exposure (PEB) process so as to make uniform the degree of diffusion of photoacids in various chemical amplification resists after the removal of the protective film.

While it is confirmed that a part of the particles deposited to the protective film after the liquid immersion exposure are transferred to the corresponding location of the resist film after the removal of the protective film, the rate of particle transfer can be decreased by controlling the surface potential of the wafer W to a low potential level by removing the protective film by using the cleaning liquid (such as 2-butanol) as noted above. For example, it is possible to control the surface potential level after removal of the protective film to 1.26V as compared with the surface potential level of 1.1V before removal of the protective film.

Thus, by carrying out the cleaning process by using the cleaning liquid (2-butanol, for example), it becomes possible to control the surface potential level of the wafer W to a low potential level, and it becomes also possible to attain the similar effect also in the case of cleaning a wafer by a process other than the process of removing the protective film conducted for a wafer W not formed with the protective film, by using the cleaning liquid (such as 2-butanol).

Upon completion of the cleaning after the exposure process, the wafer W is taken out from the exposure apparatus 34 by the first wafer transfer part 30A and is introduced into the heat treatment apparatus 50 inside the heating and cooling unit (PEB) 50A by way of the first wafer transfer part 30A.

Therein, the wafer W is cooled roughly by being placed on the cooling plate 62 and is then placed upon the hot plate 51 and is heated to the predetermined temperature. With this, the post exposure baking (PEB) process for causing the photoacids formed from the acid generator in the resist film into the interior thereof is carried out (step S10).

Thereby, the resist components cause chemical reaction as a result of catalytic action of the acid thus formed and the region where this reaction has taken place is changed to be soluble to the developing liquid in the case of a positive resist.

In the case the entirety of the protective film TC is removed, the timing and duration of wafer transfer by the first and second wafer transfer parts 30A and 30B are controlled at the time of the cleaning process after the exposure in response to the signal from the controller 70, such that the interval after the cleaning of the wafer W to the post exposure (PEB) process is controlled constant.

In this case, it is also possible to control the interval by accommodating the wafer W temporarily in a buffer cassette 35 and take out the wafer W therefrom by the second wafer transfer part 30B after elapse of a predetermined time. With this, it becomes possible to control the resist film thickness to constant and it becomes possible to suppress the chemical reaction of the resist film.

The wafer W thus processed with the PEB processing is then taken out from the heat treatment apparatus 50 of the heating and cooling unit 50A by the first wafer transfer part 30A and is introduced into the processing part 2 via the transfer unit of the shelf unit U3.

In the processing unit 2, the wafer W is introduced in to the developing unit (DEV) 26 by the main transfer unit A3 and a developing liquid is supplied to a surface thereof from a developing liquid nozzle provided inside the developing unit (DEV) 26. With this, developing is carried out (step S11).

Thereby, a part of the resist film on the surface of the wafer W changed to be soluble to the developing solution caused dissolving, and a predetermined resist pattern is formed. Further, a rinse liquid of purified water, or the like, is supplied to the wafer W and spin drying is conducted thereafter by throwing off the lines liquid.

For example, it is possible to provide a dry gas nozzle for supplying a dry gas such as dry air or dry nitrogen in the unit and facilitate the drying process of the wafer W by applying the dry gas to the wafer W while carrying out the spin drying process. Alternatively, the spin drying process may be replaced by such a process of applying the dry gas.

Thereafter, the wafer W is taken out from the developing unit (DEV) 26 by the main transfer unit A3 and is returned to the carrier 10 on the loading part 11 via the main transfer unit A2 and the transfer unit A1, and with this, a series of coating and developing processing is finished.

According to the foregoing embodiment of the present invention, it becomes possible to remove the water droplets, particles, stains, or the like, formed on the surface of the wafer W, more precisely on the surface of the protective film, at the time of the liquid immersion exposure, and it becomes possible to form a highly miniaturized resist pattern with excellent in-plane uniformity with regard to the lien width.

Thus, it becomes possible to carry out high-precision coating and developing process to the wafer W with high in-plane uniformity.

While explanation has been made in the foregoing embodiment with regard to the case of forming a bottom anti-reflection coating (BARC) film on the surface of the wafer W, forming a resist film (R) thereon, and further forming a top anti-reflection coating film (protective film) TC thereon, the same effect is attained also in the case in which the bottom anti-reflection coating (BARC) is omitted.

In this case, the wafer processing is carried out in the order of: resist coating process→prebaking process→top anti-reflection coating film application process→prebaking process→pre-exposure cleaning process→liquid immersion exposure process→post exposure cleaning process→post exposure baking process→developing process.

While the foregoing embodiment has been explained for the case of providing the first and second cleaning liquid nozzles 45A and 45B inside the cleaning apparatus 34 disposed to the interface part 3, it is also possible to provide the first cleaning liquid supply nozzle 45A to the resist film coating unit 25.

Next, experiments conducted for confirming the effects of the present invention will be explained.

### EXAMPLE 1

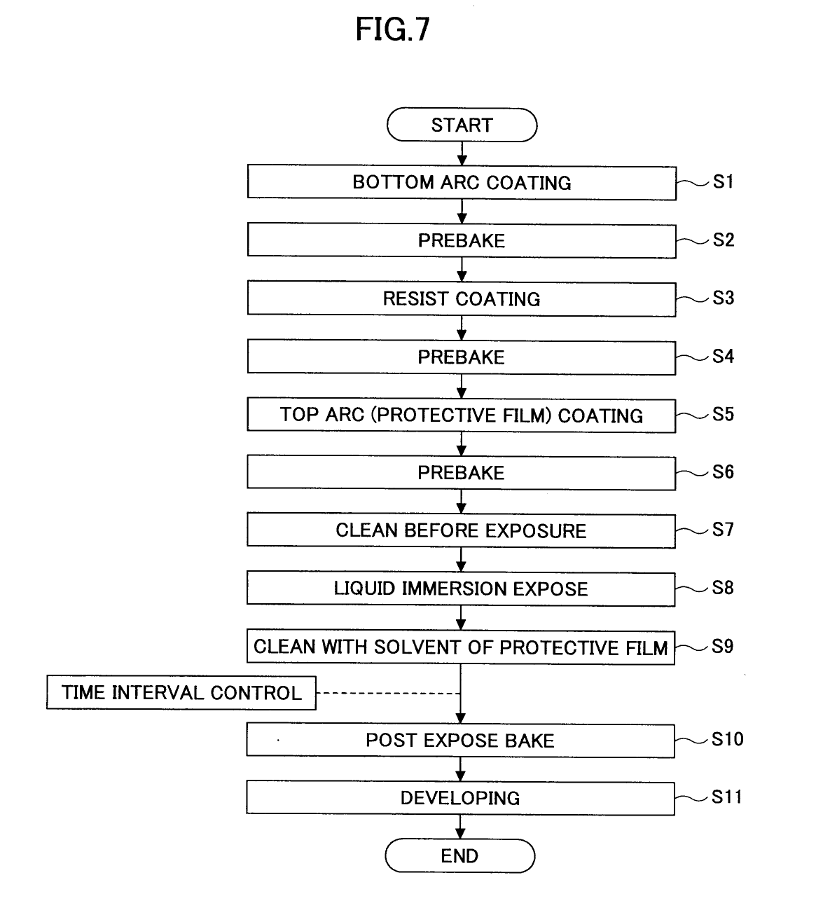

With Example 1, dry stains are formed intentionally on the wafer surface (precisely on the surface of the protective film) after the liquid immersion exposure process similarly to the dry stains formed in the cleaning process, and the number of the stains is counted for the case of carrying out the cleaning process with purified water (Comparative Example 1) and for the case of carrying out the cleaning process with 2-butanol (Example 1). FIG. 8 shows the result of the investigation.

Referring to FIG. 8, there are 34 stains before the cleaning process in the case of Comparative Example 1 wherein the number of the stains is reduced by two after the cleaning and 32 stains were observed when the cleaning is conducted by using purified water in Comparative Example 1. On the other hand, in the case of Example 1 that uses 2-butanol, the 33 stains observed before the cleaning are reduced to only 6 stains after the cleaning, thus resulting in elimination of 27 stains. Thus, it is confirmed that the present invention is effective for removing the stains.

### EXAMPLE 2

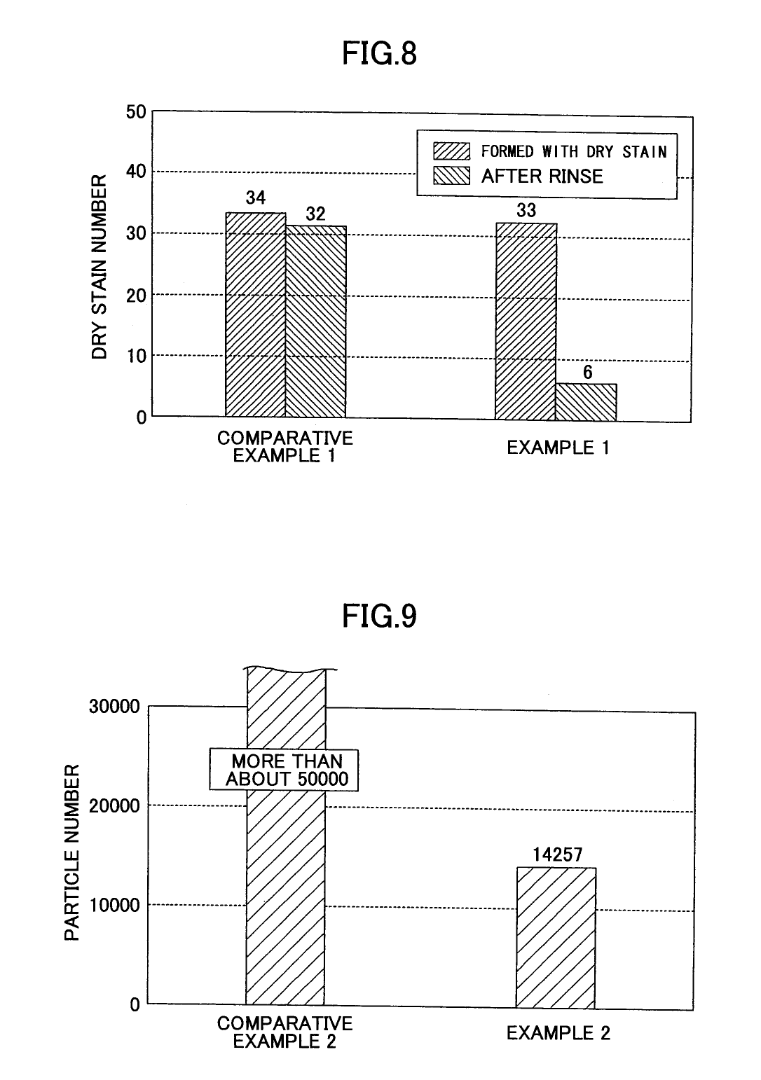

In Example 2, cleaning was made on the one hand by using purified water (Comparative Example 2) and on the other hand by using 2-butanol, and the number of particles on the surface was compared after carrying out developing processing. FIG. 9 shows the results of Example 2.

Referring to FIG. 9, more than 50,000 particles were observed in the case of Comparative Example 2 in which the cleaning process is conducted by using purified water, while in the case of Example 2 in which the cleaning is conducted with 2-butanol, the observed number of the parcels was reduced to 14,257. Thus, it was confirmed that it becomes possible to suppress the degradation of resolution and degradation of precision of line width caused by the residue of the protective film, by carrying out the cleaning process while using 2-butanol (Example 2).

### EXAMPLE 3

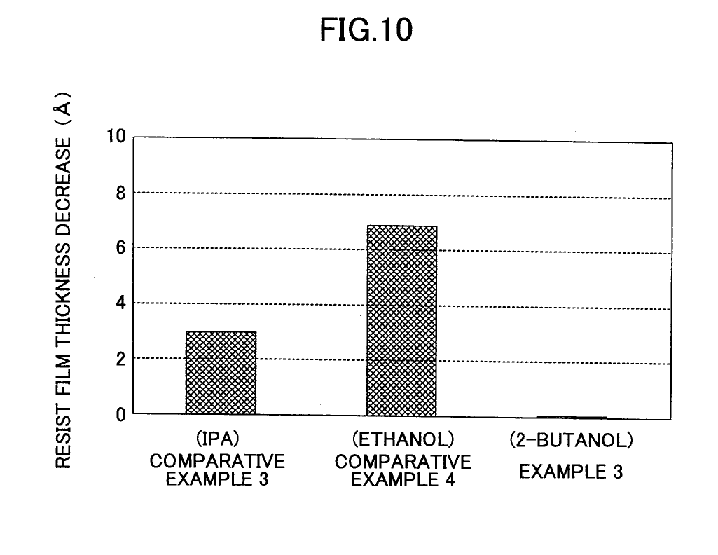

In Example 3, damaging to the resist film was investigated while using various cleaning liquids of: isopropyl alcohol (IPA) (Comparative Example 3); ethanol (Comparative Example 4); and 2-butanol (Example 3). FIG. 10 shows the results of Example 3.

Referring to FIG. 10, the amount of thinning of the resist film thickness was about 3A in the case of using IPA (Comparative Example 3), while the amount of thinning of the resist film thickness was about 7 Å when ethanol is used (Comparative Example 4). On the other hand, in the case 2-buthanol is used (Example 3), the amount of decrease of the resist film thickness was almost zero.

These results indicate that there is caused no damaging to the resist film when 2-butanol is used for the cleaning liquid.

### EXAMPLE 4

Next, the relationship between the surface potential and the particle transfer rate (or particle removal rate) is investigated in relation to the mechanism of transfer of the particles adhered to the protective film after the liquid immersion exposure process, at the time of removal of the protective film, by comparing: the method (Example A) of removing the protective film before the developing process while using the cleaning liquid of the present embodiment (2-butanol); the method (Example B) of removing the protective film by using conventional developing processing (developing liquid+rinse with purified water).

Table 1 shows the result of the investigation. In this experiment, the substrate coated with a resist film (referred to hereinafter as substrate W) was contaminated with Si particles and particle measurement (particle measurement size: 100 nm or more) was carried out. The surface potential was made by using Kelvin method (oscillating capacitance method).

TABLE 1

Surface
potential (V)

| | Before | After | | |
|---|---|---|---|---|
| | removal of | removal of | Particle | Particle |
| | protective | protective | transfer | removal |
| | film | film | rate | rate |
| Comparative | 1.1 | −4.6 | 20% | 80% |
| Example B | | | | |
| Example A | 1.1 | 1.26 | 4% | 96% |

*surface potential measurement: Kelvin method (oscillation capacitance method)
Particles: Si
Measured particle size: ≧100 nm

Referring to Table 1, it can be seen that the surface potential was 1.1V before removal of the protective film in Comparative Example B, while the surface potential becomes −4.6V after the protective film is removed and rinsing with purified water. In this case the particle transfer rate was 20% (particle removal rate was 80%).

The results of Table 1 can be interpreted as follows.

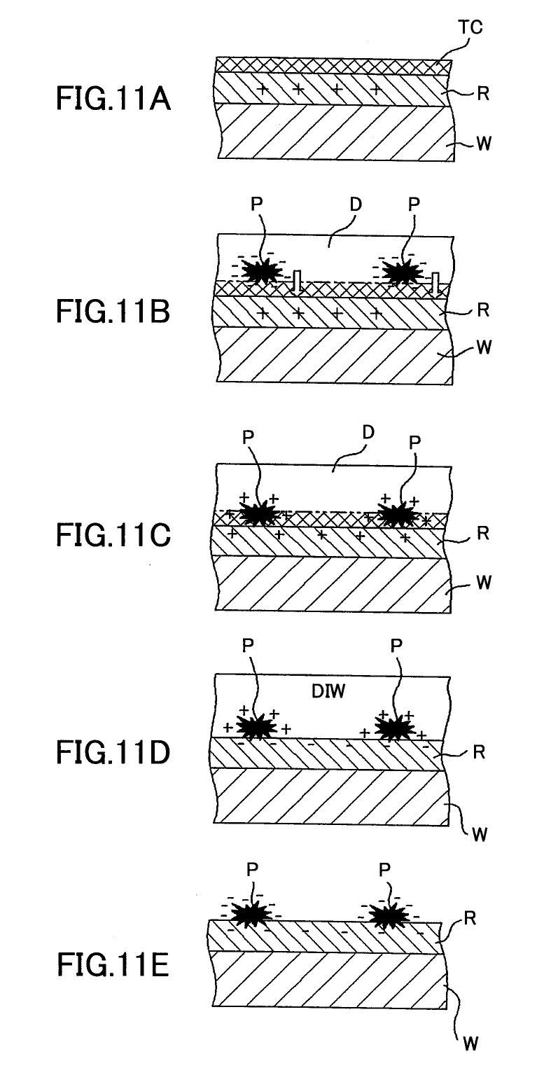

As shown in FIG. 11A, the surface potential of the resist film after the developing process is positive (+), and thus, the substrate W is also charged to positive. On the other hand, as shown in FIG. 11B, the particles P in the developing liquid are charged to negative (−), and thus, there occurs electrostatic attraction of the particles P upon the substrate W.

Thereafter, the potential of the attracted particles should become positive (+) in due course and take the same potential level of the substrate W.

Now, when the substrate W is applied with rinse by using purified water (DIW) as shown in FIG. 11D, the substrate W is charged to negative (−), and because of this, the particles P, charged positive and adsorbed upon the substrate W, show the tendency to remain on the substrate W as a result of electric interaction with the substrate W.

Thus, it is explained that the increase of particle transfer rate to the substrate W is caused as a result of increase of the negative electric charge amount of the substrate W, which in turn is caused after the removal of the protective film as a result of the developing process of Comparative Example B that uses the developing liquid D and rinse process with purified water (DIW).

With Example A of Table 1, on the other hand, the surface potential prior to the removal of the protective film was 1.1V, while the surface potential after removal of the protective film by using the cleaning liquid (2-butanol) was 1.26V. Further, the particle transfer rate was 4% (particle removal rate is 96%). The same particle transfer rate (particle removal rate) was obtained also in the case the developing process (developing liquid+purified water rinse 9 is carried out after the removal of the protective film, similarly to the case of Comparative Example B.

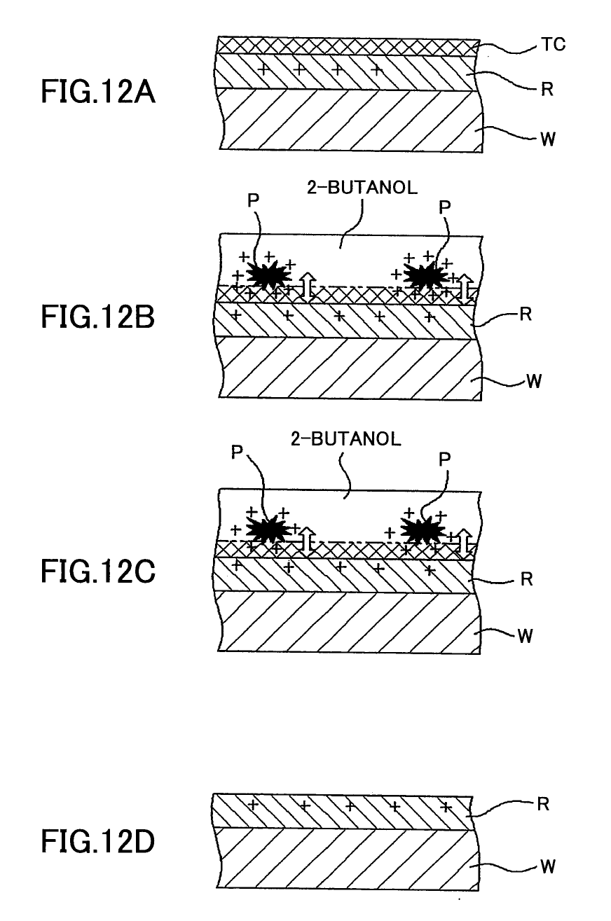

It is believed that this reflects the situation that the substrate W is charged to positive (+) immediately after the developing as shown in FIG. 12A, while the cleaning liquid (2-butanol) used for removing the protective film is charged to positive (+) to the potential level equal to the potential level of the substrate W, and thus, there occurs electric repulsion of the particles P to the substrate W as shown in FIG. 12C. As a result, the particle transfer rate is decreased as shown in FIG. 12D, and there is caused increase of the particle removal rate.

While the foregoing embodiments and examples have been explained for the case of using 2-butanol, similar effects are attained also in the case of using the alcohol having a branched chain similar to 2-butanol, such as n-decane, 2-octanol, n-pentanol, isobutyl alcohol, isoamyl ether, 2-methyl-1-butanol, dibutyl ether, 2-methyl-2-butanol, 2-methyl-4-pentanol or a mixture thereof.

While the present invention has been explained for preferred embodiments, the present invention is not limited to such specific embodiments and various variations and modifications may be made within the scope of the invention described in patent claims.

The present invention is based on Japanese priority applications 2006-250293 and 2007-040297 respectively filed on Sep. 15, 2006 and Feb. 21, 2007, the entire contents of which are incorporated herein as reference.

What is claimed is:

1. An exposure and developing method, comprising the steps of:
exposing a resist film formed on a substrate to be processed and carrying a protective film on a surface thereof with an exposure light, in the state that there is formed a liquid layer transparent to said exposure light upon said resist film; and
developing said resist film after said exposing step,
wherein there is provided a cleaning step before said developing step, with a cleaning liquid that contains a solvent of said protective film.

2. The exposure and developing method as claimed in claim 1, further comprising, after said cleaning step, a heat treatment step that stabilizes said resist film by heating said substrate.

3. The exposure and developing method as claimed in claim 2, wherein said cleaning step comprises a step of removing a surface part of said protective film with said cleaning liquid.

4. The exposure and developing method as claimed in claim 2, wherein said cleaning step comprises a step of removing said protective film for an entirety thereof with said cleaning liquid.

5. The exposure and developing method as claimed in claim 4, wherein an interval after removing said protective film for an entirety thereof with said cleaning step to a start of said heat treatment step is controlled constant.

6. The exposure and developing method as claimed in claim 5, wherein said cleaning liquid is selected from a group consisting of: 2-butanol, n-decane, 2-octanol, n-pentanol, isobutyl alcohol, diisoamyl ether, 2-methyl-1-butanol, dibutyl ether, 2-methyl-2-butanol, 2-methyl-4-pentanol, and a mixture thereof.

7. The exposure and developing method as claimed in claim 4, wherein said cleaning liquid is selected from a group consisting of: 2-butanol, n-decane, 2-octanol, n-pentanol, isobutyl alcohol, diisoamyl ether, 2-methyl-1-butanol, dibutyl ether, 2-methyl-2-butanol, 2-methyl-4-pentanol, and a mixture thereof.

8. The exposure and developing method as claimed in claim 2, wherein said cleaning liquid is selected from a group consisting of: 2-butanol, n-decane, 2-octanol, n-pentanol, isobutyl alcohol, diisoamyl ether, 2-methyl-1-butanol, dibutyl ether, 2-methyl-2-butanol, 2-methyl-4-pentanol, and a mixture thereof.

9. The exposure and developing method as claimed in claim 1, wherein said cleaning step comprises a step of removing a surface part of said protective film with said cleaning liquid.

10. The exposure and developing method as claimed in claim 9, wherein said cleaning liquid is selected from a group consisting of: 2-butanol, n-decane, 2-octanol, n-pentanol, isobutyl alcohol, diisoamyl ether, 2-methyl-1-butanol, dibutyl ether, 2-methyl-2-butanol, 2-methyl-4-pentanol, and a mixture thereof.

11. The exposure and developing method as claimed in claim 1, wherein said cleaning step comprises a step of removing said protective film for an entirety thereof with said cleaning liquid.

12. The exposure and developing method as claimed in claim 11, further comprising, after said cleaning step, a heat treatment step heating said resist film, and wherein an interval after removal of an entirety of said protective film with said cleaning step to a start of said heat treatment step is controlled constant.

13. The exposure and developing method as claimed in claim 12, wherein said cleaning liquid is selected from a group consisting of: 2-butanol, n-decane, 2-octanol, n-pentanol, isobutyl alcohol, diisoamyl ether, 2-methyl-1-butanol, dibutyl ether, 2-methyl-2-butanol, 2-methyl-4-pentanol, and a mixture thereof.

14. The exposure and developing method as claimed in claim 11, wherein said cleaning liquid is selected from a group consisting of: 2-butanol, n-decane, 2-octanol, n-pentanol, isobutyl alcohol, diisoamyl ether, 2-methyl-1-butanol, dibutyl ether, 2-methyl-2-butanol, 2-methyl-4-pentanol, and a mixture thereof.

15. The exposure and developing method as claimed in claim 1, wherein said cleaning liquid is selected from a group consisting of: 2-butanol, n-decane, 2-octanol, n-pentanol, isobutyl alcohol, diisoamyl ether, 2-methyl-1-butanol, dibutyl ether, 2-methyl-2-butanol, 2-methyl-4-pentanol, and a mixture thereof.
